(19) United States
(12) Patent Application Publication
(10) Pub. No.: US 2018/0334006 A1
(43) Pub. Date: Nov. 22, 2018

(54) METHODS AND APPARATUS FOR VEHICLE SUSPENSION

(71) Applicant: Fox Factory, Inc., Scotts Valley, CA (US)

(72) Inventors: Bryan Wesley ANDERSON, Santa Cruz, CA (US); William O. BROWN, IV, Aptos, CA (US); Mario GALASSO, Sandy Hook, CT (US)

(73) Assignee: Fox Factory, Inc., Scotts Valley, CA (US)

(21) Appl. No.: 16/049,428

(22) Filed: Jul. 30, 2018

Related U.S. Application Data
(63) Continuation of application No. 15/071,121, filed on Mar. 15, 2016.
(60) Provisional application No. 62/133,892, filed on Mar. 16, 2015.

(51) Int. Cl. B60G 15/06; B60G 15/12; B60G 13/08; F16F 9/44; F16F 9/516; F16F 9/088; F16F 9/348

(52) U.S. Cl. CPC B60G 15/062; B60G 2300/12; B60G 13/08; F16F 9/446; F16F 9/516; F16F 9/088; F16F 9/348; B60G 2202/24; B60G 2202/312; B60G 2202/314; B60G 2204/12; B60G 2206/41; B60G 2300/122; B60G 2300/124; B60G 15/12

(57) ABSTRACT

In one embodiment, a vehicle suspension assembly is described having a spring tube with a spring component disposed within the spring tube. A damper tube is slidably coupled to an interior of the spring tube, and a through shaft is disposed within the spring tube and also the damper tube. A damper piston is disposed within the damper tube and the damper piston is coupled to the through shaft. A damper valve assembly including an adjustable valve is also coupled to the through shaft. The vehicle suspension assembly further includes a pressure compensation feature coupled to the damper valve assembly.

### CROSS-REFERENCE TO RELATED APPLICATIONS

This patent application is a continuation of and claims priority to and benefit of co-pending U.S. patent application Ser. No. 15/071,121, filed Mar. 15, 2016, entitled “METHODS AND APPARATUS FOR VEHICLE SUSPENSION”, by Anderson et al., having Attorney Docket No. FOX-P3-16-15-US, assigned to the assignee of the present application, which is incorporated herein in its entirety by reference thereto.

The patent application Ser. No. 15/071,121 claims priority to and benefit of U.S. provisional patent application 62/133,892, filed Mar. 16, 2015, entitled “METHODS AND APPARATUS FOR VEHICLE SUSPENSION”, by Anderson et al., having Attorney Docket No. FOX-P3-16-15-US.PRO, assigned to the assignee of the present application, which is incorporated herein in its entirety by reference thereto.

### BACKGROUND

Embodiments of the invention generally relate to methods and apparatus for use in vehicle suspension. Particular embodiments relate to methods and apparatus for combined damper and spring arrangements.

### BRIEF DESCRIPTION OF THE DRAWINGS

FIG. 1A is a cross sectional view of one embodiment of a vehicle suspension assembly in accordance with the present invention in which the vehicle suspension assembly is in a non-compressed state.

FIG. 1B is a cross sectional view of one embodiment of a vehicle suspension assembly in accordance with the present invention in which the vehicle suspension assembly is in a partially-compressed state.

FIG. 1C is a cross sectional view of one embodiment of a vehicle suspension assembly in accordance with the present invention in which the vehicle suspension assembly is in a fully-compressed state.

FIG. 2 is a perspective view of one embodiment of a vehicle suspension assembly in accordance with the present invention.

FIG. 3 is a cross sectional view of one embodiment of a vehicle suspension assembly in accordance with the present invention in which the vehicle suspension assembly includes a coiled spring and is in a non-compressed state.

FIG. 4 is a close-up sectional view of a portion of a damper valve assembly in accordance with one embodiment of the present invention.

FIG. 5 is a close-up sectional view of a portion of a pressure compensation feature in accordance with one embodiment of the present invention.

FIG. 6 is a side sectional view of another embodiment of a vehicle suspension assembly in accordance with one embodiment of the present invention.

The drawings referred to in this description should be understood as not drawn to scale unless specifically noted as such. Labels used herein, descriptive or otherwise, are for convenience or illustration only and should not be construed as limiting of the invention disclosed herein or necessarily indicative of any prior art or admission thereof.

### DESCRIPTIONS OF EMBODIMENTS

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

There are many types of vehicles that use suspension components for absorbing and dissipating energy imparted to the vehicle by the terrain over which the vehicle travels.

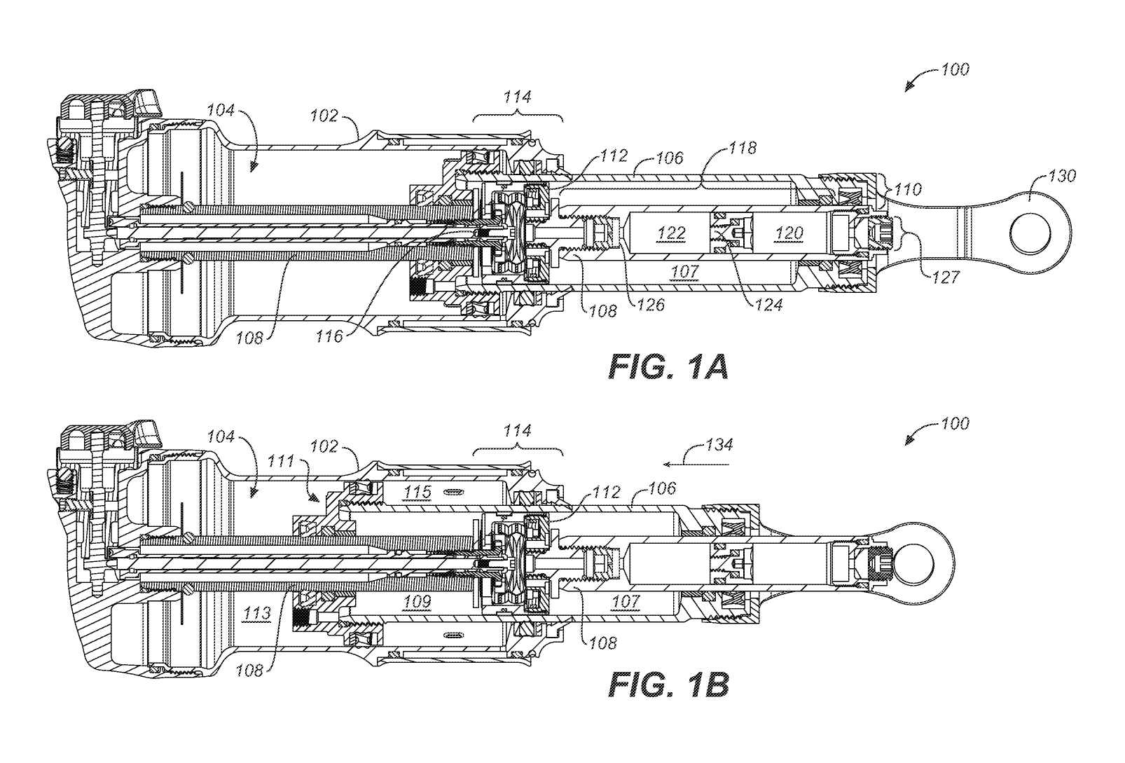

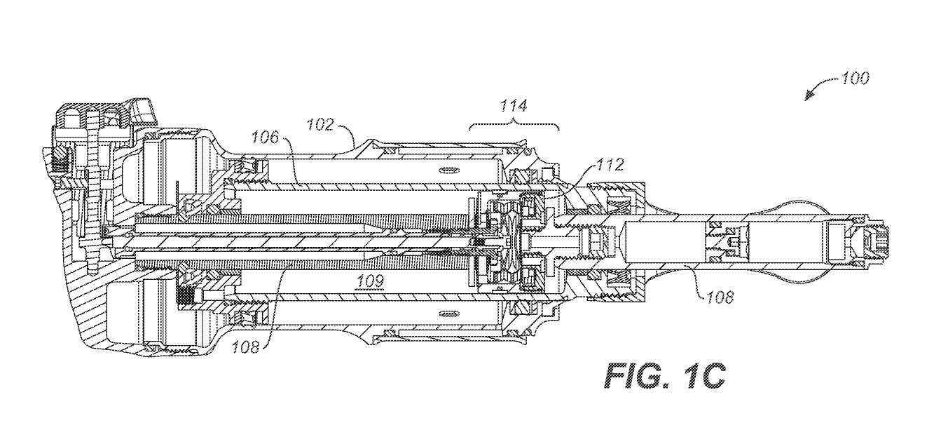

FIGS. 1A, 1B, and 1C show, in cross-section, a vehicle suspension assembly 100 herein also referred to as a shock absorber. FIGS. 1A, 1B and 1C, respectively, vehicle suspension assembly 100 is three positions: non-compressed; partially-compressed; and fully-compressed. For purposes of clarity, the following discussion will begin with detailed description of the various components comprising vehicle suspension assembly 100. The following discussion will then include a detailed description of the operation of various components of vehicle suspension assembly 100.

### Components of a Vehicle Suspension Assembly

As shown in the embodiment of FIG. 1A, vehicle suspension assembly 100 includes a spring tube 102. Spring tube 102 has a spring component 104 disposed therein. As will be described in detail below, in one embodiment as shown, for example, in FIG. 1A, spring component 104 is an air spring. In other embodiments, spring component 104 is, for example, a coiled spring.

Referring still to the embodiment of FIG. 1A, a damper tube 106 is slidably coupled to an interior of spring tube 102. In so doing, and as will be described below in conjunction with FIGS. 1B and 1C, damper tube 106 is able to move (i.e. translate) with respect to spring tube 102 such that damper tube 106 can extend into and out of spring tube 102. Damper tube 106 surrounds and defines an annular damping chamber 107 which surrounds through shaft 108. Typically, damping chamber 107 is filled with a damping fluid such as, for example, hydraulic oil. Vehicle suspension assembly 100 also includes a through shaft 108 which is disposed within both spring tube 102 and damper tube 106. In the embodiment of FIG. 1A, a portion 127 of through shaft 108 is shown exposed to the atmosphere by extending beyond the end 110 of damper tube 106.

In FIG. 1A, a damper piston 112 is disposed within said damper tube 106. Damper piston 112 is coupled to through shaft 108. As will be further described below in conjunction with at least FIGS. 1B and 1C, as damper tube 106 moves into and out of spring tube 102, damper tube 106 will move with respect to damper piston 112. In one embodiment, vehicle suspension assembly 100 further includes a damper valve assembly 114. Damper valve assembly 114 also includes an adjustable valve 116. Due to the reduced size of the numerous elements comprising damper valve assembly 114 in FIG. 1A, a more detailed discussion of the numerous elements comprising damper valve assembly 114 is provided in the below discussion of the operation of vehicle suspension assembly 100. The below discussion will also reference Figures in which the elements comprising damper valve assembly 114 (including adjustable valve 116) of the present embodiment are enlarged compared to FIG. 1A.

Referring still to the embodiment of FIG. 1A, vehicle suspension assembly 100 further includes a pressure compensation feature 118 coupled to damper valve assembly 114. In the present embodiment, pressure compensation feature 118 includes a chamber 120 of pressurized gas, a chamber 122 of fluid, and a floating piston 124 disposed between chamber 120 of pressurized gas and chamber 122 of fluid. Additionally, in the present embodiment, pressure compensation feature 118 further includes a flow restrictor 126 coupled to chamber 122 of fluid. In the present embodiment, flow restrictor 126 is comprised of one or more filters. As with damper valve assembly 114, due to the reduced size of the numerous elements comprising pressure compensation feature 118 in FIG. 1A, a more detailed discussion of the numerous elements (e.g. elements 120, 122, 124, and 126) comprising pressure compensation feature 118 is provided in the below discussion of the operation of vehicle suspension assembly 100. The below discussion will also reference Figures in which the elements comprising pressure compensation feature 118 of the present embodiment are enlarged compared to FIG. 1A.

Vehicle suspension assembly 100, of the embodiment of FIG. 1A, also includes a mounting component 128 (hidden in FIG. 1A, but shown in various Figures below) coupled to spring tube 102. Further, vehicle suspension assembly 100, of the embodiment of FIG. 1A, also includes a mounting component (partially shown as 130) coupled to damper tube 106.

### Operation of a Vehicle Suspension Assembly

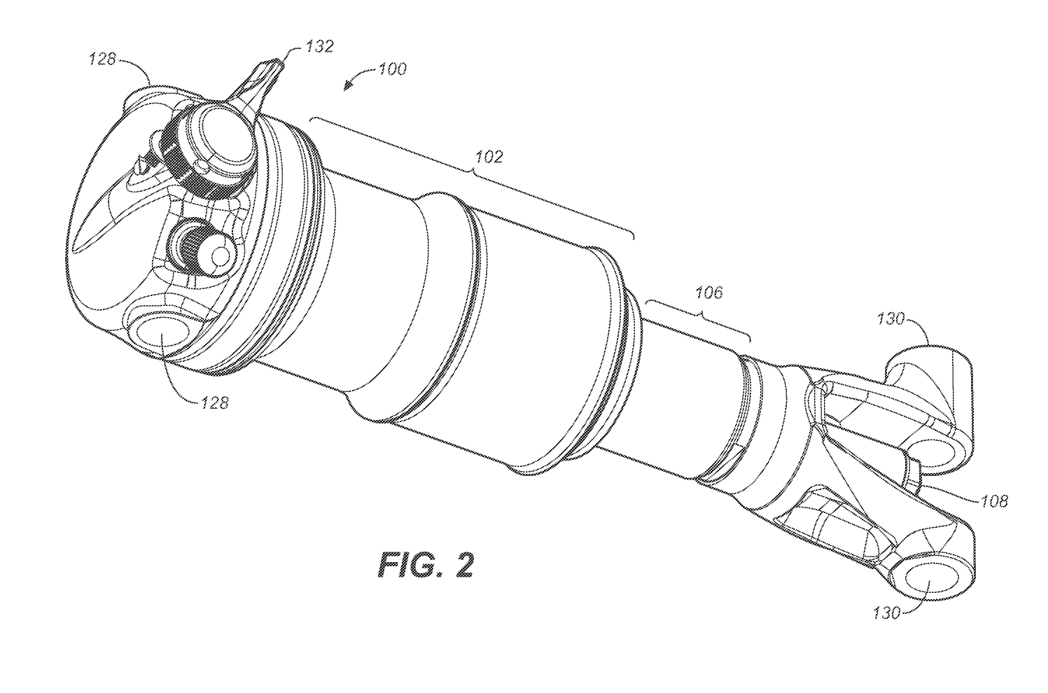

As an overview of the operation of an embodiment of the present vehicle suspension assembly, refer now to FIG. 2. FIG. 2 is a perspective view of one embodiment of vehicle suspension assembly 100, in accordance with the present invention. FIG. 2 clearly shows mounting components 128 and 130 as well as various other features of vehicle suspension assembly 100. For example, FIG. 2 also shows a lever 132 for controlling adjustable valve 116 of FIG. 1A. In use, vehicle suspension assembly 100 is coupled to a vehicle by, for example, coupling mounting component 130 to a first location on a vehicle, and coupling mounting component 128 to a second location on the vehicle. It should be noted that embodiments of the present invention are well suited to having vehicle suspension assembly 100 coupled to any of numerous locations on any of numerous vehicle types. These vehicle types include but are not limited to bicycles, two-wheeled powered vehicles, three and/or four wheeled powered vehicles, watercraft, snow machines, and any of innumerable other vehicles in which a vehicle suspension assembly is desired.

Referring still to FIG. 2, during operation, a vehicle compression event causes mounting components 128 and 130 to move towards each other. Conversely, a vehicle extension event (or rebound) causes mounting components 128 and 130 to move away from each other. As mounting component 130 is coupled to damper tube 106, and mounting component 128 is coupled to spring tube 102, a compression event thereby causes damper tube 106 to move with respect to spring tube 102. As a result, during operation (and from the perspective of spring tube 102), vehicle compression events cause damper tube 106 to extend into spring tube 102. Conversely, vehicle extension events cause damper tube 106 to translate or extend out of spring tube 102. For purposes of clarity, in the present application, damper tube 106 will be described as translating or moving with respect to spring tube 102. It should be noted, however, that whether spring tube 102 moves with respect to damper tube 106, or vice versa, or whether both spring tube 102 and damper tube 106 move, is a matter of perspective.

Referring still to FIG. 2, as compression events occur and damper tube 106 extends into spring tube 102, a greater portion of through shaft 108 (which is coupled to spring tube 102) will extend beyond the end of damper tube 106. As extension events occur and damper tube 106 moves out of spring tube 102, a lesser portion of through shaft 108 will extend beyond the end of damper tube 106.

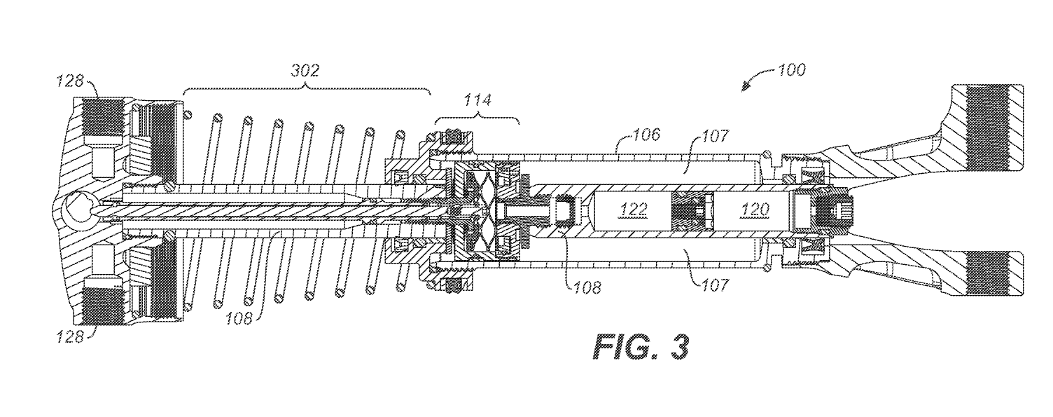

As mentioned above, in some embodiments, the present invention does not include an air spring component 104 of FIG. 1A. FIG. 3 is a cross sectional view of one such embodiment in which a coiled spring 302 is used instead of air spring component 104 of FIG. 1A. In such an embodiment, vehicle suspension assembly 100 includes a through shaft 108 which is coupled to a mounting component 128 (hidden). Unlike other embodiments (in which damper tube 106 slides into and out of a spring tube), damper tube 106 is, instead, slidably coupled to through shaft 108. In so doing, damper tube 106 is able to translate about through shaft 108 toward, or away from, mounting component 128. As in other embodiments, in the coiled spring embodiment of FIG. 3, a greater length of through shaft 108 extends outside of damper tube 106 as damper tube 106 translates toward mounting component 128. Other than the use of coiled spring 302 instead of an air spring component, the rest of the damping operations performed with damper tube 106 and its cooperating components (e.g., damper valve assembly 114) are the same as for embodiments including an air spring. A discussion of the operation of spring component 104 is provided below.

Referring again to FIG. 1A, a detailed description of the operation of an embodiment of the present vehicle suspension assembly 100 is provided. At FIG. 1A, vehicle suspension assembly 100 is in a non-compressed state. As compression events occur, vehicle suspension assembly 100 moves to a partially-compressed state as depicted in FIG. 1B. That is, in FIG. 1B, damper tube 106 has moved (in the direction of arrow 134) from its non-compressed state (shown in FIG. 1A) partially into spring tube 102. Referring still to FIG. 1B, as a result of the movement of damper tube 106 into spring tube 102, damping piston 112 is now closer to the right side of damper tube 106. Due to the relative movement of damping piston 112 and damper tube 106, damping chamber 107 (of FIG. 1A) has now been divided into a first portion 107 located on one side of damping piston 112, and second portion 109 located on the other side of damping piston 112. As damping piston 112 and damper tube 106 move relative to each other, damping fluid flows through damper valve assembly 114. The flow of damping fluid through damper valve assembly 114 (restricted by the various valves as will be described below) dissipates energy in the form of heat (and therein provides damping).

Referring to FIGS. 1A-1C, in one embodiment, through shaft 108 has substantially the same diameter on either side of damper valve assembly 114. As a result, as damping piston 112 and damper tube 106 move relative to each other, the total volume of the damping chamber defined by damper tube 106 (e.g., 107 in FIG. 1A, 107 and 109 in FIG. 1B, and 109 in FIG. 1C) remains substantially constant. In so doing, embodiments in accordance with the present invention maintain a constant static internal pressure regardless of the position of damper tube 106 or damping piston 112.

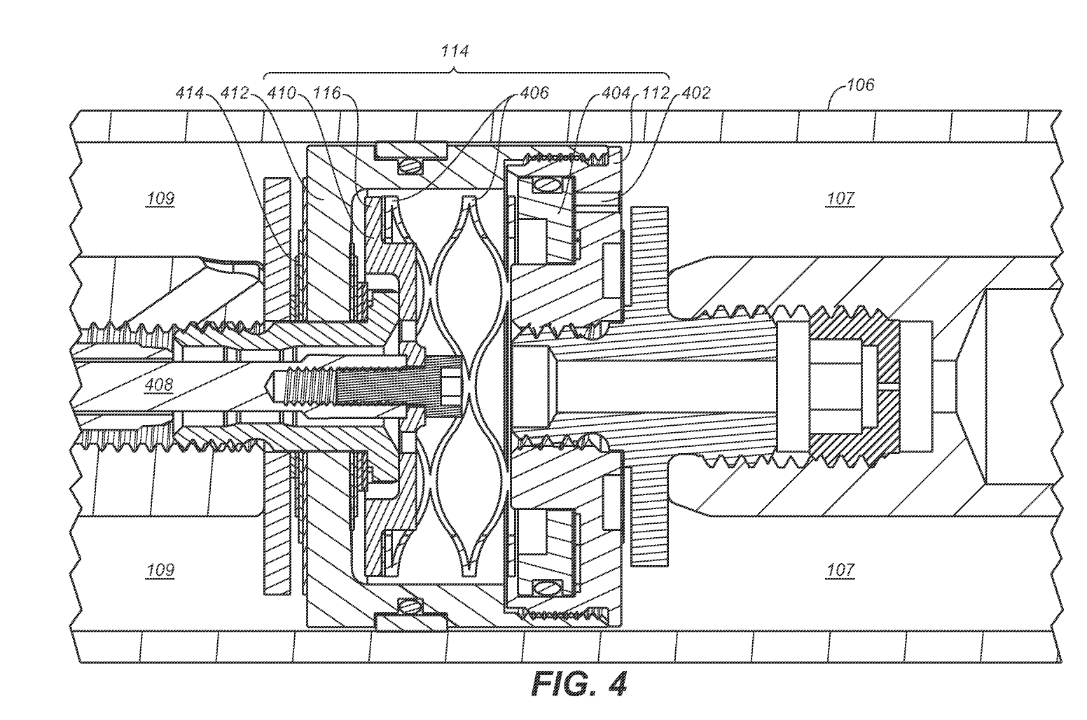

Referring now to FIG. 4, a close-up sectional view is shown of a portion of damper valve assembly 114 in accordance with one embodiment of the present invention. As described above, as damping piston 112 and damper tube 106 (FIG. 1A) move relative to each other, during compression, damping fluid is forced to flow from damping chamber 107 through damper valve assembly 114 and into damping chamber 109. Referring again to FIG. 4, the flow path of the damping fluid is described in detail below. Specifically, in the present embodiment, the damping fluid flows through opening 402 in damping piston 112 and pushes valve 404 open to create a flow path toward damping chamber 109. Although not shown here, a compression check valve ensures flow of the damping fluid in the desired direction (i.e., from damping chamber 107 towards damping chamber 109). Valve 404, however, has a backing force applied thereto by spring 406. The amount of force applied to valve 404 by spring 406 is partially dependent upon adjustable valve 116.

Referring still to FIG. 4, adjustable valve 116 applies a preload force to spring 406. That is, lever 132 of FIG. 2 is coupled to a compression adjust rod 408. Compression adjust rod 408 is coupled to lever 132 of FIG. 2. By moving lever 132 (FIG. 2), compression adjust rod 408 moves axially to apply a force to adjustable valve 116 such that the desired preload force is applied, via adjustable valve 116, to spring 406. Once the damping fluid has overcome the force exerted by valve 404, the damping fluid flows through spring 406, and then through an opening 410 in adjustable valve 116. The damping fluid then flows through an opening 412 and past a compression shim stack 414. In one embodiment, the compression shim stack is comprised of circumferential flexible shims. At that point, the damping fluid flows into damping chamber 109.

Referring still to FIG. 4, during rebound, damping fluid is forced to flow from damping chamber 109, through damper valve assembly 114, and back into damping chamber 107. In one embodiment, the rebound damping flow path has similar features (adjustable valve, shim stacks, check valves, etc.) to the compression damping flow path, but the damping fluid flows along a different “rebound” path back into damping chamber 107. The present invention is also well suited to embodiments in which the rebound damping fluid flow path is more or less similar to the compression damping fluid flow path.

Referring again to FIG. 1B, vehicle suspension assembly 100, can be described as having a spring component “in series” with the damper tube 106. That is, in one embodiment, spring component 104 is physically situated adjacent or “in series” with damper tube 106, along the central axis of vehicle suspension assembly 100. As damper tube 106 slides into spring tube 102, the end 111 of damper tube 106 compresses the gas contained in the volume defined by spring tube 102 and end 111 of damper tube 106. In so doing, an “air spring” is created. In one embodiment of the present vehicle suspension assembly 100, as damper tube 106 extends into spring tube 102, a chamber 115 is created. In such an embodiment, gas is then moved from chamber 113 and into newly created chamber 115. Conversely, as damper tube 106 is extended out of spring tube 102, gas in chamber 115 is compressed and forced into chamber 113. In some embodiments of the present vehicle suspension assembly 100, the size of chambers 113 and 115 are defined such that at full extension (when damper tube 106 is fully extended out of spring tube 102), the net force exerted by the air spring on damper tube 106 is near zero.

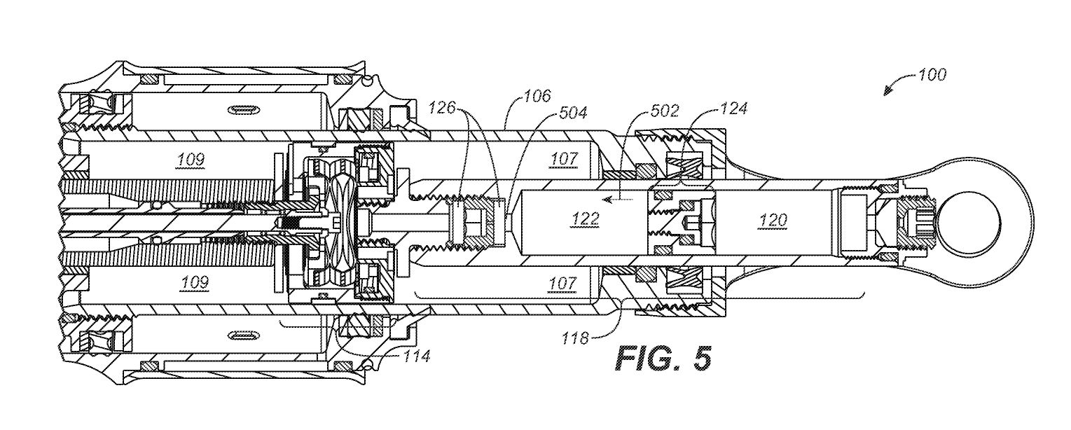

Referring now to FIG. 5, a close up sectional view is shown of a portion of pressure compensation feature 118 in accordance with one embodiment of the present invention. During operation, for example as damping fluid flows through the various valves from damping chamber 107 to damping chamber 109, a pressure differential may be temporarily generated. Specifically, the flow of damping fluid through the various valves may create a pressure drop from one side of a valve to the other side of the valve. In some situations (such as, for example, a compression event), the pressure, within vehicle suspension assembly 100, is greater on the side of the valve nearer damping chamber 107 than the pressure on the side of the valve nearer damping chamber 109. If not addressed, such a situation could result damping fluid being forced in an undesired direction. In one embodiment, vehicle suspension assembly 100 includes a pressure compensation feature 118 to counteract or compensate for such a pressure differential. Specifically, in the situation described above, pressure compensation feature 118 creates a “back pressure” that compensates for any pressure drop. In one embodiment of the present vehicle suspension assembly 100, pressure compensation feature 118 creates the back pressure in the following manner. Chamber 120 contains a pressurized gas which is able to expand or be compressed as needed. In a situation, as above, where a back pressure is needed, the pressurized gas within chamber 120 expands (due to the above described pressure differential) and acts upon floating piston 124. In turn, floating piston 124 is moved to the left as shown by arrow 502, and applies pressure to damping fluid within chamber 122. Damping fluid is able to exit chamber 122 via a “pin hole”, not shown, where the size of the pin hole limits dynamic flow and corresponding operational dynamic pressure. However, sufficient damping fluid flow is realized to adjust the surrounding damping fluid pressure. As a result, pressure compensation feature 118 increases the pressure (via opening 504 and through flow restrictor 126) in the damping fluid flow path to overcome any “valve-induced” pressure drop. In so doing, pressure compensation feature 118 maintains a positive pressure during the dynamic flow of damping fluid across the valves such that the damping fluid flows in the desired direction. It should be noted that the above described pressure drop is a generated only temporarily and as a function of the damping fluid dynamically flowing across various valves. Once the damping fluid flow has ceased and the system has reached stasis, vehicle suspension assembly 100 maintains a constant static internal pressure regardless of the position of damper tube 106 or damping piston 112.

Referring still to FIG. 5, in one embodiment flow restrictor 126 achieves the desired flow restriction using a plurality of filters. In addition to restricting fluid flow in order to maintain the desired back pressures, flow restrictor 126 also provides protection against particles becoming trapped within the narrow orifice fluidically coupling chamber 122 and the damping fluid flow path. Further, in the embodiment of FIG. 5, flow restrictor 126 has a first filter or set of filters disposed adjacent chamber 122, and a second filter or set of filters disposed closer to damper valve assembly 114. In such an embodiment, flow restrictor 126 provides two separate areas for filtering damping fluid. Such an arrangement also reduces the likelihood of a single particle obstructing damping fluid flow (particularly through the narrow orifice or pin hole) near chamber 122.

With reference still to FIG. 5, in addition to providing back pressure when needed, pressure compensation feature 118 is also able to compensate for heating of vehicle suspension assembly 100. For example, some conventional shock absorbers will “lock up” if subjected to heating. In some conventional shock absorbers, merely exposing the shock to sunlight for some period of time will sufficiently heat the shock to the point where the shock absorber will lock up and become non-functional. In embodiments of the present vehicle suspension assembly 100, pressure compensation feature 118 prevents such lock up. As one example, in embodiments of the present vehicle suspension assembly 100, expansion in the overall damping fluid volume (due to, for example, exposing vehicle suspension assembly 100 to sunlight) is absorbed or “taken up” by movement of floating piston 124 against the compressible gas in chamber 120. As a result, rather than locking up and becoming unusable, vehicle suspension assembly 100 compensates for the expanded damping fluid volume using pressure compensation feature 118, and remains fully functional.

It should further be understood that damping fluid expands due to heat and conversely contracts when cold. If the damping fluid is contained in a sealed chamber with no “flexible” components to allow this volume change (e.g. in conventional shock absorbers), the internal pressure of the conventional shock absorber would rise very rapidly as the oil expanded. This rise in pressure can cause extra seal friction and ultimately, for example, burst a damper tube or extruding rubber seals. On the other end of the spectrum, in extreme cold, the oil can contract to a volume that is less than the total capacity of the damper tube. In this case, a “gap” is generated wherein a portion of the shock travel occurs with no damping. In the present vehicle suspension assembly 100, pressure compensation feature 118 prevents a pressure rise (by floating piston 124 moving toward chamber 120 and thereby receiving damping fluid into chamber 122) and consequent damage caused by expansion of damping fluid. Additionally, in the present vehicle suspension assembly 100, pressure compensation feature 118 also prevents “gap” generation (by floating piston 124 moving toward chamber 122 and thereby flowing damping fluid out of chamber 122 into the fluid path of vehicle suspension assembly 100) and consequent travel of a damping piston without damping. Hence, pressure compensation feature 118 of the present vehicle suspension assembly 100 provides multiple important safeguards and benefits.

Significant advantages are achieved in the various embodiments of the present vehicle suspension assembly 100. As mentioned above, embodiments in accordance with the present invention maintain a constant static internal pressure regardless of the position of damper tube 106 or damping piston 112. Thus, when stasis of the system is achieved, damping chamber pressure in, for example, damping chambers 107 and/or 109 remains constant. Hence, vehicle suspension assembly 100 does not see sustained increased internal pressures based on the location of damping piston 112 with respect to damper tube 106. As a result, vehicle suspension assembly 100 has embodiments in which the internal pressures of the damping chambers are lower than the internal pressures found in conventional shock absorbers. Additionally, in various embodiments of the present vehicle suspension assembly 100, the internal pressures remain lower than the pressures developed in conventional shock absorbers. The lower pressures utilized in various embodiments of vehicle suspension assembly 100 enable vehicle suspension assembly 100 to utilize lower sealing pressures between sealing components. For example, the sealing pressure between damping piston 112 and the interior surface of damper tube 106 can, in various embodiments, be lower than the sealing pressure required for pistons and mating surfaces in conventional shock absorbers. The reduced sealing pressures of various embodiments of the present vehicle suspension assembly 100, in turn, result in vehicle suspension assembly 100 having reduced frictional forces or internal drag compared to conventional shock absorbers. Although the above discussion specifically refers to the sealing pressure between damping piston 112 and the interior surface of damper tube 106, it should be noted that the lower operating pressure of embodiments of the present vehicle suspension assembly 100 affects the sealing between numerous mating components. As a result, in various embodiments of the present vehicle suspension assembly 100, the cumulative reduction in frictional forces or reduction in internal drag compared to conventional shock absorbers is substantial.

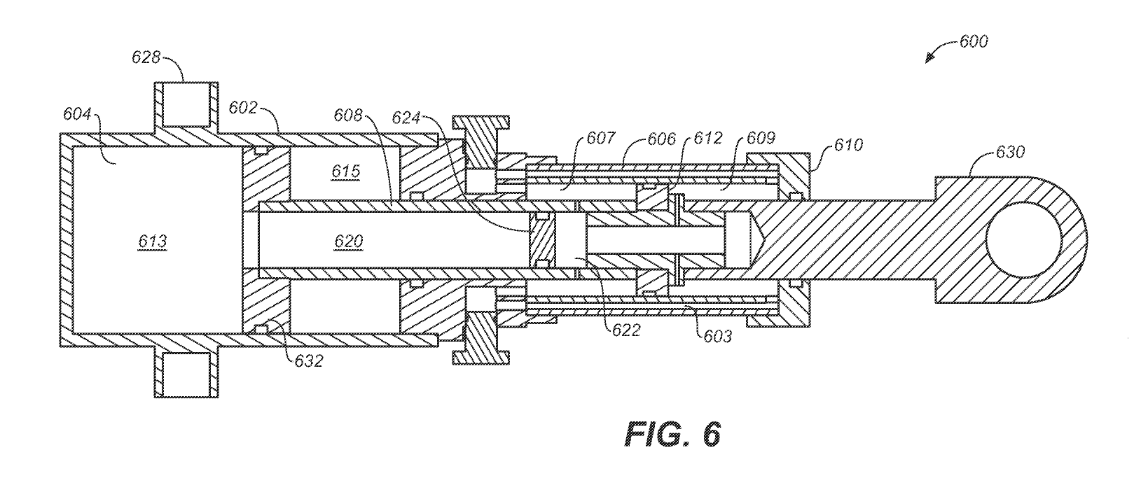

Referring now to FIG. 6, a side sectional view of another embodiment of a vehicle suspension assembly 600 is shown. While many of the features are similar to the features of vehicle suspension assembly 100 shown in FIGS. 1A-FIG. 5, the relationships of the components are slightly different and there are different features. In the embodiment of FIG. 6 an air spring piston 632 and the damper piston 612 are coupled via through shaft 608 and are axially movable.

As shown in the embodiment of FIG. 6, vehicle suspension assembly 600 includes a spring tube 602. Spring tube 602 has a spring component 604 disposed therein. In one embodiment as shown, for example, in FIG. 6, spring component 604 is an air spring. In other embodiments, spring component 604 is, for example, a coiled spring. Vehicle suspension assembly 600 further includes a through shaft 608 which is able to concurrently extend into or out of spring tube 602 and damper tube 606. In the embodiment of FIG. 6, through shaft 608 is able to be exposed to the atmosphere by extending beyond the end 610 of damper tube 606.

Referring still to the embodiment of FIG. 6, a damper tube 606 is fixedly coupled to spring tube 602. Thus, unlike in vehicle suspension assembly 100, in vehicle suspension assembly 600, damper tube 606 is not able to move (i.e. translate) with respect to spring tube 602. Damper tube 606 surrounds and defines an annular damping chamber 607 which surrounds through shaft 608. Typically, damping chamber 607 is filled with a damping fluid such as, for example, hydraulic oil.

In FIG. 6, a damper piston 612 is disposed within said damper tube 606. Damper piston 612 is coupled to through shaft 608. As through shaft 608 moves into and out of spring tube 602 and damper tube 606, damper piston 612 will move with respect to damper tube 606. In one embodiment, vehicle suspension assembly 600 further includes recirculating channels, typically shown as 603, formed into the walls of damper tube 606.

Referring still to the embodiment of FIG. 6, vehicle suspension assembly 600 further includes a pressure compensation feature with through shaft 608. In the present embodiment, the pressure compensation feature includes a chamber 620 of pressurized gas, a chamber 622 of fluid, and a floating piston 624 disposed between chamber 620 of pressurized gas and chamber 622 of fluid. The operation of the pressure compensation feature of vehicle suspension assembly 600 is analogous to the operation described above for pressure compensation feature 118 of vehicle suspension assembly 100.

Vehicle suspension assembly 600, of the embodiment of FIG. 6, also includes a mounting component 628 coupled to spring tube 602. Further, vehicle suspension assembly 600, of the embodiment of FIG. 6, also includes a mounting component (partially shown as 630) coupled to damper tube 606.

Referring still to FIG. 6, in operation, vehicle suspension assembly 600 operates similarly to vehicle suspension assembly 100. However, in the present vehicle suspension assembly 600, rather than moving the damping fluid through a damper valve assembly, the damping fluid is moved through recirculating channels 603. That is, when a compression event occurs, mounting point 630, which is coupled to through shaft 608, causes through shaft 608 to move into damper tube 606 and spring tube 602. In turn, damper piston 612 is moved along damper tube 606 towards spring tube 602. As a result, damping fluid in annular chamber 607 is pushed through recirculating channels 603 and ultimately into annular chamber 609. The flow of damping fluid through recirculating channels 603 (restricted by various valves, not shown) dissipates energy in the form of heat (and therein provides damping). During rebound, damping fluid is similarly forced from chamber 609, through recirculating channels 603, and back into chamber 607.

In the embodiment of FIG. 6, as through shaft 608 slides into spring tube 602, air piston 632 compresses the gas contained in the volume defined by spring tube 602 and air piston 632. In so doing, an “air spring” is created. In one embodiment of the present vehicle suspension assembly 600, as air piston 632 extends into spring tube 602, a chamber 615 is created. In such an embodiment, gas is then moved from chamber 613 and into newly created chamber 615. Conversely, as air piston 632 is extended out of spring tube 602 (due to movement of through shaft 608), gas in chamber 615 is compressed and forced into chamber 613. In some embodiments of the present vehicle suspension assembly 600, the size of chambers 613 and 615 are defined such that at full extension (when through shaft 608 is fully extended out of spring tube 602), the net force exerted by air spring 604 on through shaft 608 is near zero.

The present vehicle suspension assembly 600 has several benefits. First, because damper tube 606 does not translate with respect to spring tube 602, no dynamic seal is required between damper tube 606 and spring tube 602. Further, in vehicle suspension assembly 600, through shaft 608 does not extend through air spring piston 632. As a result, air spring 632 has a large footprint (equal to the cross sectional area of the interior of spring tube 602), and provides a significant spring component force.

It should be appreciated that embodiments, as described herein, can be utilized or implemented alone or in combination with one another. While the present invention has been described in particular embodiments, it should be appreciated that the present invention should not be construed as limited by such embodiments, but rather it should defined by the following claims.

What is claimed is:

1. A vehicle suspension assembly comprising:
a spring tube;
a spring component disposed within said spring tube;
a damper tube slidably coupled to an interior of said spring tube;
a through shaft disposed within said spring tube and said damper tube;
a damper piston disposed within said damper tube and coupled to said through shaft;
a damper valve assembly coupled to said through shaft, said damper valve assembly including an adjustable valve; and
a pressure compensation feature disposed within said through shaft, said pressure compensation feature comprising:
a chamber of pressurized gas;
a chamber of fluid; and
a floating piston disposed between said chamber of pressurized gas and said chamber of fluid.

2. The vehicle suspension assembly of claim 1 further comprising:
a mounting component coupled to said spring tube.

3. The vehicle suspension assembly of claim 1 wherein said spring component is selected from the group consisting of: a coiled spring and an air spring.

4. The vehicle suspension assembly of claim 1 further comprising:
a mounting component coupled to said damper tube.

5. The vehicle suspension assembly of claim 1 wherein said pressure compensation feature further comprises:
a flow restrictor coupled to said chamber of fluid.

6. The vehicle suspension assembly of claim 5 wherein said flow restrictor is comprised of at least one filter.

7. The vehicle suspension assembly of claim 5 wherein said flow restrictor is comprised of a plurality of filters.

8. A vehicle suspension assembly comprising:
a spring tube;
a spring component disposed within said spring tube;
a damper tube fixedly coupled to said spring tube, said damper tube having recirculation channels formed therein;
an adjustable valve coupled to said recirculation channels;
a through shaft disposed within said spring tube and said damper tube;
a damper piston disposed within said damper tube and coupled to said through shaft;
a pressure compensation feature disposed within said through shaft, said pressure compensation feature comprising:
a chamber of pressurized gas;
a chamber of fluid; and
a floating piston disposed between said chamber of pressurized gas and said chamber of fluid.

9. The vehicle suspension assembly of claim 8 further comprising:
a mounting component coupled to said spring tube.

10. The vehicle suspension assembly of claim 8 wherein said spring component is selected from the group consisting of: a coiled spring and an air spring.

11. The vehicle suspension assembly of claim 8 wherein said through shaft does not translate with respect to said spring component.

12. The vehicle suspension assembly of claim 8 further comprising:
a mounting component coupled to said through shaft.
